(19) United States
(12) Patent Application Publication
(10) Pub. No.: US 2023/0057373 A1
(43) Pub. Date: Feb. 23, 2023

(54) METHODS AND APPARATUS TO INCREMENTALLY TRAIN A MODEL

(71) Applicant: McAfee, LLC, San Jose, CA (US)

(72) Inventors: Mayur Bhole, Bangalore (IN); Tirumaleswar Reddy Konda, Bangalore (IN); Urmil Parikh, Bangalore (IN); Piyush Pramod Joshi, Bangalore (IN)

(21) Appl. No.: 17/404,856

(22) Filed: Aug. 17, 2021

(51) Int. Cl. G06N 20/00; H04L 29/12

(52) U.S. Cl. CPC G06N 20/00; H04L 61/1511

(57) ABSTRACT

A disclosed example includes obtaining first data associated with a first device class; build a vocabulary including keys that map to values for an incremental training batch, the incremental training batch based on the first data and exemplars from memory, the exemplars associated with a set of device classes, the exemplars include first means closest to first overall means for ones of the set of the device classes that were stored to the at least one memory during a previous incremental training batch; train a model based on the keys as input features and an updated set of the device classes that includes the first device class; and select a set of samples from the first data and the exemplars, the set of the samples includes second means closest to second overall means for ones of the updated set of the device classes.

### FIELD OF THE DISCLOSURE

This disclosure relates generally to machine learning, and, more particularly, to methods and apparatus to incrementally train a model.

### BACKGROUND

In recent years, machine learning (e.g., using neural networks) has become increasingly used to train, among other things, models to make predictions or decisions without being explicitly programmed to do so. One or more methods of machine learning may be utilized to train models. Such methods include, but are not limited to, supervised, unsupervised, and reinforcement learning.

### BRIEF DESCRIPTION OF THE DRAWINGS

FIG. 1 is a block diagram illustrating an example system to enable device identification based on incrementally training example models.

FIG. 2 is a block diagram illustrating the example system of FIG. 1 showing a first set of aspects in further detail for initial training of the example models.

FIG. 3 is a block diagram illustrating the example system of FIG. 1 showing a second set of aspects in further detail for incremental training of the example models.

FIG. 4 is an illustration of an example decision matrix for use in training a model utilizing a complete data set.

FIG. 5 is an illustration of an example decision matrix for use in incrementally training a model.

FIG. 6 is a flowchart representative of an example process that may be performed using machine readable instructions which may be executed to implement the example device identification service of FIGS. 1, 2, and/or 3 to train the models.

FIG. 7 is a block diagram of an example processor platform structured to execute the instructions of FIG. 6 to implement the example device identification service of FIGS. 1, 2, and/or 3.

FIG. 8 is a block diagram of an example software distribution platform to distribute software (e.g., software corresponding to the example computer readable instructions of FIG. 6) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Network services may be implemented in a router, or any other network device or set of devices, to provide network security such as, for example, protecting devices connected to the router from both internal and external security threats (e.g., malware, viruses, spyware, adware). In some examples, network security is provided by enforcing security policies for these devices. Correctly identifying these devices when they connect to the network device can be useful to enforce the security policies. Devices may be identified by a router collecting fingerprint data (e.g., Universal Plug and Play (UPnP) data, multicast domain name system (mDNS) data, domain name system (DNS) data) for a device identification service. The fingerprint data provides information about the data accessed by devices via the network. In some examples, the device identification service utilizes the fingerprint data to build machine learning models for identifying classes (e.g., device types, device manufacturers, device model information) associated with devices (e.g., device classes). These machine learning models may be Deep Neural Network models. In one example, the device identification service receives DNS fingerprint data indicating patterns of data accessed by the devices. The models are built by the identification service based on the DNS fingerprint data. As a result, the models may be able to recognize the data access patterns to identify classes associated with the devices (e.g., device classes). Such classes may correspond to device types including, for example, a gaming device (e.g., gaming Nintendo®), an Internet of Things (IoT) device (e.g., a camera, a light, a printer, a thermometer), a streaming device (e.g., Amazon Fire TV stick, Google Chromecast, Roku® Streaming Stick®, Belkin™ Wemo® Switch), etc.

In one example, the device identification service implements a classical batch machine learning approach to train a model. The classical batch machine learning approach may train a model in incremental training batches. In some examples, the classical batch machine learning approach needs a complete data set for each incremental training batch to identify both current device classes (e.g., device classes not previously trained) and previous device classes (e.g., device classes that have been previously trained and are being retrained). For example, a first training batch includes first fingerprint data from the network device, the first fingerprint data associated with first device classes. The device identification service may train the model utilizing the first fingerprint data and store the first fingerprint data to have a complete data set for subsequent training batches. A second training batch may include the first fingerprint data and second fingerprint data from the network device, the second fingerprint data associated with second device classes. The device identification service may train the model to identify the second device classes utilizing the second fingerprint data and retrain the model to identify the first device classes utilizing the first fingerprint data. The device identification service may store the first fingerprint data and the second fingerprint data to have a complete data set for subsequent training batches.

However, a classical batch machine learning approach storing the complete data set for subsequent training batches may not be feasible because the network device collects a huge amount of fingerprint data (e.g., approximately one million fingerprints of DNS fingerprint data per day for a network located in a household) for the device identification service. Further, new devices continuously onboarding the network to be identified by the device identification service may cause a huge amount of fingerprint data collected by the router (e.g., approximately 2.5 million fingerprints per day for a network located in a household) for the device identification service. Therefore, the complete data set may continuously increase to include fingerprint data associated with new devices for accurately identifying up-to-date devices connected to the network. In some examples, storing the complete data set is not feasible due to data privacy and protection laws (e.g., General Data Protection Regulation law) and/or cost constraints (e.g., huge monetary costs) associated with data storage. The data privacy and protections laws may restrict the duration of fingerprint being stored (e.g., a data retention policy of three months). In other examples, processing the complete data set is not feasible due to significant monetary costs associated with processing the complete data set to train the models. As a result from not storing the complete data set for each incremental training batch, a current incremental training batch may not be able to utilize all previous data from previous incremental training batches to train the models. The absence of the previous data while training the models may lead to catastrophic forgetting in the models. Catastrophic forgetting refers to the models forgetting information learned from previous incremental training batches utilizing the previous data associated with classes (e.g., not retaining knowledge acquired from the classes). For example, a first training batch includes first fingerprint data from the network device, the first fingerprint data associated with first device classes. The device identification service may train the model utilizing the first fingerprint data to learn the first device classes for device identification. However, the first fingerprint data may not be stored. Therefore, a second training batch may include second fingerprint data associated with second device classes but not include the first fingerprint data. The device identification service may train the model utilizing the second fingerprint data to learn the second device classes for device identification. However, the model may forget the first device classes (e.g., catastrophic forgetting) upon the second incremental training iteration learning the second device classes. Catastrophic forgetting of device classes learned by the models in previous incremental training iterations may lead to the device identification service not correctly identifying devices in a network.

Additionally, the classical training batch approach may not be feasible because the classical training batch is limited to a fixed number of classes, representations, and input features. The identification of new device classes in an incremental training batch may be a human-assisted process with the fingerprints manually being analyzed and validated to determine the device classes not previously associated with the device identification service. The fingerprint data and device classes may change over incremental training iterations such as, for example, when training text data. For example, the fingerprint data includes different words and device classes per incremental training batch. Therefore, an approach to update input features (e.g., the words) and classes (e.g., the device classes) for training the models is needed.

Examples disclosed herein overcome the challenges that arise from the cost constraints of data retention and the data privacy and protection laws by implementing an incremental learning approach for training models. Such incremental learning approach overcomes the challenges while providing up-to-date models by storing exemplar representations of fingerprint data for each increment to be utilized by a subsequent incremental training batch. Exemplar representations may include a set of samples from the fingerprint data stored in an encoded form to provide privacy compliance. For example, encoding the set of samples prevents storing personally identifiable information that can directly or indirectly identify individuals. Samples from the fingerprint data that are not included in the set of samples are to be discarded because storing a complete data set from each incremental training batch is not required to prevent catastrophic forgetting for subsequent training batches. Selecting the set of the samples for storage prevents catastrophic forgetting and reduces monetary costs associated with data storage and processing. Additionally, the incremental learning approach updates input features and device classes without the need for retraining the models from scratch.

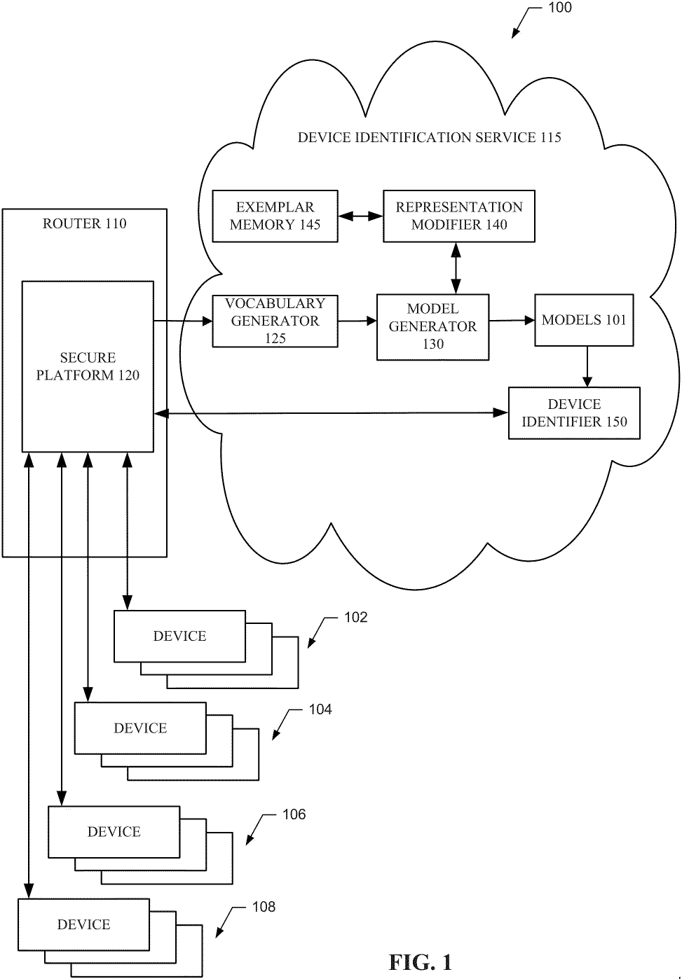

FIG. 1 is a block diagram illustrating an example system 100 to enable device identification based on incrementally training the example models 101. The example system 100 includes example devices 102, 104, 106, 108, an example router 110, and an example device identification service 115.

The devices 102, 104, 106, 108 are internet-connected devices. The devices 102, 104, 106, 108 may correspond to device classes of one or more class types. In one example, a class type is device type. Device types may include gaming devices (e.g., gaming Nintendo®), Internet of Things (IoT) devices (e.g., a camera, a light, a printer, a thermostat), streaming devices (e.g., Amazon Fire TV stick, Google Chromecast, Roku® Streaming Stick®, Belkin™ Wemo® Switch), etc. Further, in some examples, the class types include device manufacturer information, device model information, etc. The router 110 is a wireless router device such as, for example, a Cisco® router, a TP-Link® router, a NETGEAR® router, etc. Alternatively, the router 110 may be any other type of network device that wirelessly couples the devices 102, 104, 106, 108 to a network such as, for example, an access point, a modem, etc. Further, the router 110 wirelessly couples the devices 102, 104, 106, 108 to the device identification service 115. The device identification service 115 may be one or more storage devices and/or computing devices (e.g., servers) located at the same or different locations of a network or collection of networks (e.g., in the cloud, in edge devices) that may be accessed by the router 110. In some examples, the device identification service 115 may be used in connection with the McAfee® Secure Home Platform Cloud.

The router 110 includes an example secure platform 120 to implement network services to provide network security such as, for example, protecting devices 102, 104, 106, 108 from both internal and external security threats (e.g., malware, viruses, spyware, adware). A specific example of the secure platform 120 is the McAfee® Secure Home Platform. The secure platform 120 may discover the devices 102, 104, 106, 108 and collect data from the devices 102, 104, 106, 108 for a period of time. For example, the secure platform 120 may collect data from a device from the devices 102, 104, 106, 108 for a period of time (e.g., 48 hours) upon the secure platform 120 discovering the device. The data may be fingerprint data (e.g., UPnP data, mDNS data, DNS data) that is text-based (e.g., text data). The fingerprint data characterizes network behavior of the devices 102, 104, 106, 108 by providing information about the data accessed by the devices 102, 104, 106, 108 via the network. The fingerprint data includes fingerprints referred to as “samples.” In some examples, the fingerprint data is UPnP data, which provides an Extensible Markup Language (XML) description of characteristics of the devices 102, 104, 106, 108. The XML description of characteristics may include device type, manufacturer, model number, model description, etc. In other examples, the fingerprint data is mDNS data, which provides a textual representation of services that the devices 102, 104, 106, 108 offer. The mDNS protocol can work in conjunction with domain name system Service Discovery (DNS-SD) to discover a named list of service instances (e.g., applications running at the network application layer). Services may include printing, file transfer, music sharing, document and other file sharing, etc. provided by the devices 102, 104, 106, 108. For example, the following is a sample of mDNS data indicating a printer request from a computer device : [{“name”: “HP Photosmart C6200 series @ Elise Genzlinger’s iMac”, “service”: “._ipps._tcp”, “txtrecord”: “TxtRec:name: HP Photosmart C6200 series @ Elise Genzlinger’s iMac, type: ._ipps._tcp, host: /192.168.1.172, port: 631, txtRecord: priority=0Vadminurl=https://Elise-Genzlingers-iMac.local.:631/printers/HP_Photosmart_C6200_series?qtotal=1 txtvers=1?printer-state=3!product=(Photosmart C6200_series)&rp=printers/HP_Photosmart_C6200_series ty=Unknown?TLS=1.2ipdl=application/octet-stream,application/pdf,application/postscript,image/jpeg,image/png,image/pw g-raster” } ]. In yet other examples, the fingerprint data is DNS data, which provides a textual representation of traffic associated with the devices 102, 104, 106, 108 over the network. The traffic may include domains reached out to by the devices 102, 104, 106, 108. For example, the following is a sample of DNS data indicating domain requests from a Ring home security device : [ "wu.ring.com", "ds-firmwares.ring.com", "fw.ring.com", "ping.ring.com", "fw-ch.ring.com", "hpcam.ring.com", "iperf.ring.com", "es.ring.com", "ps.ring.com", "rss-dpd-service.ring.com" ].

The secure platform 120 sends fingerprint data including samples associated with the devices 102, 104, 106, 108 in training batches to the device identification service 115. These devices 102, 104, 106, 108 are further associated with device classes. The training batches correspond to incremental training iterations for training the models 101. For example, the secure platform 120 collects the following training batches: a first training batch including first samples collected during a first period of time (e.g., a first day), a second training batch including second samples collected during a second period of time (e.g., a second day), a third training batch including third samples collected during a third period of time (e.g., a third day), a fourth training batch including fourth samples collected during a fourth period of time (e.g., a fourth day), etc. The training batches may be sent to the secure platform 120 in response to the conclusion of the period of time or continuously throughout the period time. Alternatively, any number of training batches and devices may be utilized to train the models 101. For example, Table 1 below shows new samples per incremental training batch.

Table 1

| Device Classes | Batch T1 | Batch T2 | Batch T3 | Batch T4 |
|---|---|---|---|---|
| Gaming _Nintendo | 602 | 192 | | |
| Light | 586 | 185 | | |
| Streaming_Google | 338 | 124 | | |
| Streaming_Roku | 436 | 153 | | |
| Switch_Belkin_Wemo | 57 | 19 | | |
| Camera | | 105 | 35 | |
| Streaming_Amazon_Fire_TV | | | 156 | 59 |
| Thermostat | | | 133 | 38 |
| Printer | | | | 348 |

In one example, the secure platform 120 discovers the devices 102 during a first period of time (e.g., a first day). The first period of time may be any period of time such as, for example, 24 hours. Fingerprint data from the devices 102 is sent to the device identification service 115 to be used as an initial training batch for training the models 101. For example, assuming “Batch T1” in table 1 corresponds to the initial training batch, the initial training batch includes 602 samples from a first set of the devices 102 corresponding to the “Gaming_Nintendo” class, 586 samples from a second set of the devices 102 corresponding to the “Light” class, 338 samples from a third set of the devices 102 corresponding to the “Streaming_Google” class, etc. The secure platform 120 discovers the devices 104 during a second period of time (e.g., a second day) after the first period of time. The second period of time may be any period of time such as, for example, 24 hours. Fingerprint data from the devices 102 is sent to the device identification service 115 to be included in a second training batch for training the models 101. The devices 104 are new devices onboarding the network. Alternatively or additionally, the devices 104 may include one or more devices from the devices 102. For example, the fingerprint data for a device from the devices 102 is collected for a period of time (e.g., 48 hours upon the secure platform 120 discovering the device), which overlaps with the first period of time and the second period of time. For example, assuming “Batch T2” in table 1 corresponds to the second training batch, the second training batch includes 192 samples from a first set of the devices 102 corresponding to the “Gaming_Nintendo” class, 185 samples from a second set of the devices 102 corresponding to the “Light” class, 105 samples from a first set of the devices 104 corresponding to the “camera” class, etc. The secure platform 120 discovers the devices 106 during a third period of time (e.g., a third day) after the second period of time. The third period of time may be any period of time such as, for example, 24 hours. Fingerprint data from the devices 106 is sent to the device identification service 115 to be used as a third training batch for training the models 101. The devices 104 are new devices onboarding the network. Alternatively or additionally, the devices 104 may include one or more devices from the devices 102, 104. For example, the fingerprint data for a device from the devices 102, 104 is collected for a period of time (e.g., 48 hours upon the secure platform 120 discovering the device), which overlaps with the first period of time, the second period of time, and/or the third period of time. For example, assuming “Batch T3” in table 1 corresponds to the third training batch, the third training batch includes 35 samples from a first set of the devices 104 corresponding to the “camera” class, 156 samples from a first set of the devices 106 corresponding to the “Streaming_Amazon_Fire_TV” class, and 133 samples from a second set of the devices 106 corresponding to the “Thermostat” class. The secure platform 120 discovers the devices 108 during a fourth period of time (e.g., a fourth day) after the third period of time. The fourth period of time may be any period of time such as, for example, 24 hours. Fingerprint data from the devices 108 is sent to the device identification service 115 to be used as a fourth training batch for training the models 101. The devices 108 are new devices onboarding the network. Alternatively or additionally, the devices 108 may include one or more devices from the devices 102, 104, 106. For example, the fingerprint data for a device from the devices 102, 104, 106 is collected for a period of time (e.g., 48 hours upon the secure platform 120 discovering the device), which overlaps with the first period of time, the second period of time, the third period of time, and/or the fourth period of time. For example, assuming “Batch T4” in table 1 corresponds to the fourth training batch, the fourth training batch includes 59 samples from a first set of the devices 106 corresponding to the “Streaming_Amazon_Fire_TV” class, 38 samples from a second set of the devices 106 corresponding to the “Thermostat” class, and 348 samples from a first set of the devices 108 corresponding to the “Printer” class.

The fingerprint data from the secure platform 120 provides information for the device identification service 115 to train the models 101 for identifying the devices 102, 104, 106, 108. More particularly, in some examples, the device identification service 115 includes an example vocabulary generator 125, an example model generator 130, example models 101, an example representation modifier 140, an exemplar memory 145, and an example device identifier 150 for identifying the devices 102, 104, 106, 108.

The example vocabulary generator 125 receives a training batch including the fingerprint data from the secure platform 120. In some examples, the vocabulary generator 125 tokenizes the text-based fingerprint data by splitting the fingerprint data into words. These words may be the primary domain names, not including sub-domains. The vocabulary generator 125 selects a set of words based on the frequency of occurrence of the words. For example, the vocabulary generator 125 selects a set of domains occurring the most frequently. The vocabulary generator 125 may select a percentage or fraction of the domains (e.g., top 70% most occurring domains), a predetermined number of domains (e.g., top 40 most occurring domains), etc. Alternatively, the vocabulary generator 125 may select the set of words utilizing a different technique such as, for example, term frequency-inverse document frequency (TF-IDF). TF-IDF may be used to produce scores based on the frequency of the occurrence of the words in the fingerprint data and the frequency of the occurrence of the words in other fingerprint data.

In some examples, the training batch including the fingerprint data received by the vocabulary generator 125 is an initial training batch, indicating the models 101 have not been previously trained. In one example, the fingerprint data is from the devices 102. The vocabulary generator 125 builds a vocabulary, which may be a hash map of keys and values. Alternatively, any other representation may be the vocabulary. The hash map is a data structure that includes keys that map to values. The keys may be a set of domains (selected based on the frequency of occurrence) from the fingerprint data. The values may indicate the frequency of occurrence of the set of the words, which may be a bag-of-words model. For example, the vocabulary may be : {‘google.com’: 1, ‘belkin.com’: 2, ‘alexa.amazon.com’: 3, ‘xbcs.net’: 4,‘echo.amazon.com’: 5}. In this example, “1” represents the most frequently occurring domain and so on. Additionally, the vocabulary generator 125 extracts device classes (also referred to as output layer neurons for an output layer of a model from the models 101) associated with the fingerprint data. As a result, device classes will be associated with each sample included in the fingerprint data. The model generator 130 creates the models 101 based on the class types extracted by the vocabulary generator 125. For instance, in some examples, the models 101 include: a first model that can be used to predict the device type, a second model that can be used to predict the device manufacturer, a third model that can be used to predict the device model, etc. The model generator 130 trains the models 101 based on the training batch including the fingerprint data. For example, the model generator 130 utilizes the domains (e.g., the keys) included in the new vocabulary as input features (also referred to as input layer neurons for an input layer of a model from the models 101) to train the models 101 to predict the device classes (e.g., device type, device manufacturer, device model information) associated with the devices 102 for device identification. In one example, the model generator 130 trains a model from the models 101 by minimizing a loss function (objective function), which includes directing the model to output the correct device class for each sample included in the training batch. The representation modifier 140 selects representations from the initial training batch, referred to herein as “exemplars.” Representations of the exemplars are utilized for subsequent incremental training batches to mitigate catastrophic forgetting problem. In particular, the model generator 130 may implement the models 101 to predict multi-class probabilities for each sample associated with the device classes. These multi-class probabilities may be output vectors. For example, a multi-class probability is an output vector for a sample associated with a device class. The model generator 130 may generate an overall mean for each device class. The overall mean may also be referred to as an exemplars mean. For example, the overall mean of a device class is the mean of output vectors for each sample of the device class. The overall means are used as a measure of central tendency of the distributions for the device classes. As a result, a set of samples from each device class is selected to be exemplars based on the overall means. For example, a device class includes samples associated with output vectors. The model generator 130 may generate the means of the output vectors. The representation modifier 140 may select a set of the samples as exemplars for the device class by selecting the samples including the means closest to the overall mean for the device class. In one example, the set of the samples are the top 15% samples whose output vector means are closest to the overall mean for the device class. The top 15% of samples per class may be enough to achieve a desired class identification accuracy. The remaining samples may be discarded. However, the percentage of samples may vary based on the desired accuracy metric for the models 101. The representation modifier 140 generates exemplar representations corresponding to the selected exemplars. For example, the representation modifier 140 may generate exemplar representations by encoding the exemplars based on a vocabulary, which is the new vocabulary because no prior vocabulary is stored. For example, the vocabulary may be the following: { ‘google.com’: 1, ‘belkin.com’: 2, ‘alexa.amazon.com’: 3, ‘xbcs.net’: 4, ‘echo.amazon.com’: 5}. The exemplars for a device class may be the following: [‘alexa.amazon.com’, ‘echo.amazon.com’]. The exemplar representations encodes the exemplars to a sequence of numbers based on the vocabulary. For example, the words (e.g., domains) included in the exemplars are matched to the keys included in the vocabulary. In this example, the exemplar ‘alexa.amazon.com’ corresponds to the key ‘alexa.amazon.com’ that maps to a value of 3 in the vocabulary. Further, in this example, the exemplar ‘echo.amazon.com’ corresponds to the key ‘echo.amazon.com’ that maps to a value of 5 in the vocabulary. As a result, the exemplar representations may be the following: [3,5]. The representation modifier 140 may store the exemplar representations to an exemplar memory 145. Additionally, the new vocabulary may be stored in the exemplar memory 145.

The exemplar representations being stored prevents catastrophic forgetting of the device classes being learned in the current training batch. As a result, future training batches learning new device classes utilize the exemplar representations to not forget the previously learned training batches. Further, selecting a set of the samples for each device class and storing the set of samples in encoded form provides privacy compliance (e.g., General Data Protection Regulation law). Additionally, selecting a set of the samples for each device class reduces monetary costs associated with data storage and processing.

In other examples, the fingerprint data received by the vocabulary generator 125 is a training batch occurring after the first training batch, indicating the models 101 have been previously trained. In one example, the fingerprint data is from the devices 104. The devices 104 are new devices onboarding the network. Alternatively or additionally, the devices 104 may include one or more devices from the devices 102. For example, the fingerprint data for a device from the devices 102 is collected for a period of time (e.g., 48 hours upon the secure platform 120 discovering the device), which overlaps with the first period of time associated with the initial training batch and the second period of time associated with the current training batch. In some examples, the training batch includes new device classes not present in the previous incremental training batches. For example, the vocabulary generator 125 extracts the new device classes (also referred to as output layer neurons for an output layer of a model from the models 101) associated with the fingerprint data. The model generator 130 may update the device classes by incrementing the device classes of the models 101 to include the new device classes. As a result, the updated device classes will be associated with each sample included in the fingerprint data. In one example, the previous incremental training batches include a camera and a light. The new device classes detected in the training batch may include a thermostat. As a result, the model generator 130 may increment the device classes to include the thermostat. In some examples, the model generator 130 creates one or more new models for the models 101 based on the device classes extracted by the vocabulary generator 125. For instance, the models 101 may currently only have a first model that can be used to predict the device type. However, device classes extracted by the vocabulary generator 125 may include device manufacturer. Therefore, the vocabulary generator 125 may create a new model that can predict the device manufacturer. The representation modifier 140 decodes the exemplar representations included in the exemplar memory 145 based on a vocabulary previously stored in the exemplar memory 145 from a previous training batch. For example, the exemplar representations are the following: [3,5]. The vocabulary may be the following: { ‘google.com’: 1, ‘belkin.com’: 2, ‘alexa.amazon.com’: 3, ‘xbcs.net’: 4, ‘echo.amazon.com’: 5}. In this example, 3 of the exemplar representation corresponds to the value of 3 in the vocabulary that maps to the key ‘alexa.amazon.com’ in the vocabulary. Further, in this example, 5 of the exemplar representation corresponds to the value of 5 in the vocabulary that maps to the key ‘echo.amazon.com.’ As a result, the decoded exemplar representations for a device class may be the following: [‘alexa.amazon.com’, ‘echo.amazon.com’]. The model generator 130 may update the vocabulary stored in the exemplar memory 145 based on and the decoded exemplar representations and the training batch including the set of domains selected based on frequency of occurrence from the fingerprint data. For example, the model generator 130 may update the vocabulary stored in the exemplar memory 145 by combining new domains (e.g., the set of domains) associated with the new vocabulary and the old domains associated with the decoded exemplar representations. In some examples, the size of the vocabulary decreases because old words (e.g., domains) included in the stored vocabulary are not in the training batch and the decoded exemplar representations. In other examples, the size of the vocabulary increases because new words (e.g., domains) are in the training batch that are not included in the stored vocabulary. As a result, the vocabulary is updated to omit the old words not in the training batch and the decoded exemplar representations. Further, the model generator 130 may update the device classes in cases where there are new device classes associated with the fingerprint data. The model generator 130 utilizes the domains included in the updated vocabulary as input features (also referred to as an input layer) to train the models 101 to predict the device classes (e.g., device type, device manufacturer, device model information) associated with the devices 104 for identification. In one example, the model generator 130 trains a model from the models 101 by minimizing a loss function (objective function), which includes directing the model to output the correct device class for each sample included in the fingerprint data (e.g., loss for classification) and directing the model to reproduce the output of the correct old device class for each decoded exemplar representation (e.g., distillation loss). The representation modifier 140 selects exemplars from the training batch (including the fingerprint data and the stored exemplars) as described above in connection to describing the initial training batch.

The device identifier 150 may determine the classes associated with fingerprint data received from the secure platform 120 for device identification. For example, the secure platform 120 obtains fingerprint data from an Amazon Echo Show™ device included in the devices 102, 104, 106, 108. The secure platform 120 may export the fingerprint data to the device identifier 150. The device identifier 150 may implement the models 101 to identify the device classes. The device classes identified may include a device type as “Voice Assistant,” the device manufacturer as “Amazon,” and the device model as “Echo Show.” In some examples, the device identifier 150 performs classification at the output layer by calculating the nearest means of exemplars associated with fingerprints. In some examples, the device identifier 150 receives a fingerprint for device identification. The device identifier 150 may implement a model from the models 101 to predict probability vectors corresponding to the device classes. For example, the device identifier 150 predicts the probability vector for each device class. The device identifier 150 may determine the differences between the probability vectors and overall means corresponding to the device classes. For example, the device identifier 150 determines the difference between the probability vector for each device class and the overall mean for each device class. As described above, the model generator 130 generates the overall mean of a device class by calculating the mean of output vectors for each sample of the device class. The device class including the lowest difference (e.g., the difference of the smallest value) is the nearest mean of exemplars that is classified to fingerprint. For example, a fingerprint has the nearest mean of exemplars associated with a camera. As a result, the device identifier 150 identifies the fingerprint to be associated with a device corresponding to the device class of a camera. In response to device identification, the device identifier 150 may enforce security policies for the device based on the device class.

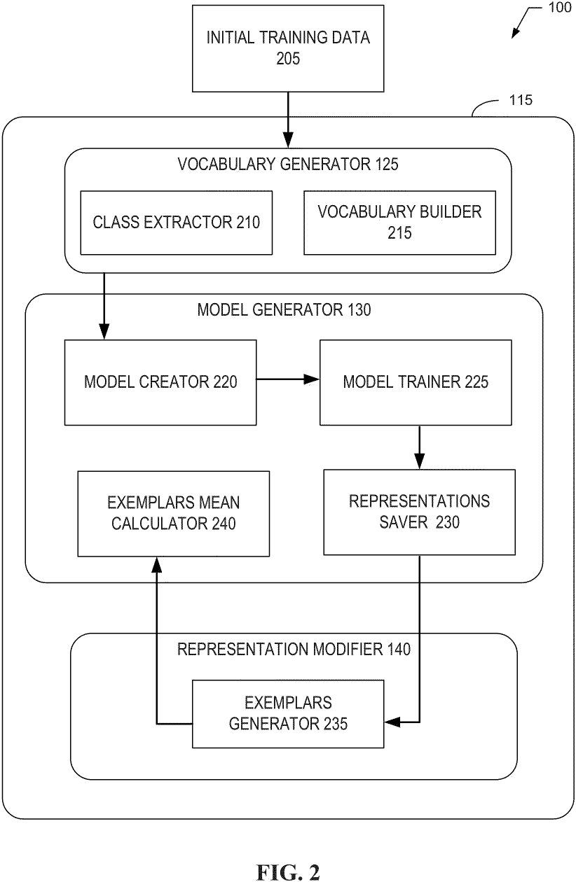

FIG. 2 is a block diagram illustrating the example system 100 of FIG. 1 showing a first set of aspects in further detail for initial training of the example models 101. The vocabulary generator 125 may utilize initial training data 205 as an initial training batch, indicating the models 101 of FIG. 1 have not been previously trained.

The vocabulary generator 125 includes an example class extractor 210 and an example vocabulary builder 215. The class extractor 210 may extract device classes from the initial training data 205. For example, the initial training data 205 includes samples from devices associated with classes (e.g., device classes). The class extractor 210 may extract a device class associated with each sample such as, for example, a device type corresponding to a sample from a device of the device type. As a result, a model will include device classes associated with each sample included in the fingerprint data. The vocabulary builder 215 may build the vocabulary based on the initial training data 205. For example, the initial training data 205 includes domains. The vocabulary builder 215 may build a hash map of keys and values. Alternatively, any other representation may be the vocabulary. The hash map is a data structure that can map keys to values. A set of the domains (selected based on the frequency of occurrence) from the fingerprint data may form the keys. The values may indicate the frequency of occurrence of the set of the domains. For example, the vocabulary may be : {‘google.com’: 1, ‘belkin.com’: 2, ‘alexa.amazon.com’: 3, ‘xbcs.net’: 4,‘echo.amazon.com’: 5}. In this example, “1” represents the most frequently occurring domain and so on. As a result, a model will include input features associated with each sample included in the fingerprint data.

The model generator 130 includes an example model creator 220, an example model trainer 225, an example representations saver 230, and an example exemplars mean calculator 240. The representation modifier 140 includes an example exemplars generator 235.

The model creator 220 may create one or more models for the models 101 of FIG. 1 based on the device classes extracted by the class extractor 210. For example, the model creator 220 creates the models 101 based on the class types (e.g., device manufacturer information, device model information) extracted by the class extractor 210. For instance, in some examples, the models 101 include: a first model that can be used to predict the device type, a second model that can be used to predict the device manufacturer, a third model that can be used to predict the device model, etc. The example model trainer 225 trains a model by minimizing a loss function (objective function), which includes directing the model to output the correct device class for each sample included in the initial training data 205. The example representations saver 230 saves the representations (e.g., model weights) associated with the loss function. The exemplars generator 235 selects a set of samples from each device class to be exemplars utilized for subsequent incremental training batches. For example, a device class includes samples associated with output vectors. The model generator 130 may generate the means of the output vectors (e.g., multi-class probabilities). The representation modifier 140 may select a set of the samples as exemplars for the device class by determining the samples including the means closest to the overall mean for the device class. For example, the overall mean of a device class is the mean of output vectors for each sample of the device class. In one example, the set of the samples are the top 15% samples whose output vector means are closest to the overall mean for the device class. The remaining samples may be discarded. The exemplars mean calculator 240 calculates the overall mean of a device class by calculating the mean of output vectors for each sample of the device class.

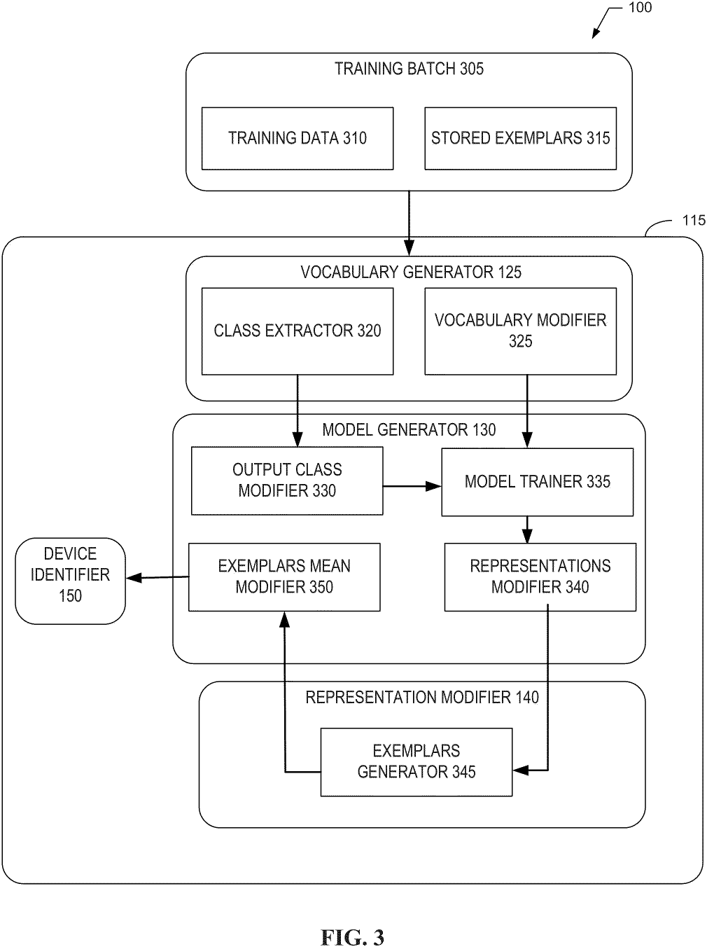

FIG. 3 is a block diagram illustrating the example system 100 of FIG. 1 showing a second set of aspects in further detail for incremental training of the example models 101. The vocabulary generator 125 may utilize a training batch 305 as a training batch occurring after the first training batch, indicating the models 101 of FIG. 1 have been previously trained.

The vocabulary generator 125 includes an example class extractor 320 and an example vocabulary modifier 325. The class extractor 320 may extract new device classes from the training data 310 not previously associated with the vocabulary generator 125. For example, the class extractor 320 compares first device classes present in the training data 310 to second device classes present in the stored exemplars 315 to determine the new device classes. In cases where device classes are present in the first device classes and not present in the second device classes, the device classes are extracted. The vocabulary modifier 325 may build the vocabulary by updating the vocabulary from a previous incremental training batch based on the training batch 305. For example, the vocabulary generator 125 combines first vocabulary present in the training data 310 and second vocabulary present in the stored exemplars 315. The vocabulary generator 125 may update the vocabulary to have a set of words based on the frequency of occurrence of the words. In one example, the vocabulary generator 125 may determine the frequency of occurrence of the words and select a percentage or fraction of the domains (e.g., top 70% most occurring domains), a predetermined number of domains (e.g., top 40 most occurring domains), etc.

The model generator 130 includes an example output class modifier 330, an example model trainer 335, an example representations modifier 340, and an example exemplars mean modifier 350. The representation modifier 140 includes an example exemplars generator 345.

The output class modifier 330 may increment the device classes of the models 101 to include the new device classes extracted from the training data 310. In one example, the class extractor 320 extracted a thermostat. As a result, the output class modifier may increment the device classes to include the thermostat. The example model trainer 335 trains the models 101 by minimizing a loss function (objective function), which includes directing the models 101 to output the correct device class for each sample included in the training data 310 (e.g., loss for classification) and directing the model to reproduce the output of the correct old device class for each stored exemplars 315 (e.g., distillation loss). The stored exemplars 315 are the decoded exemplar representations. The example representations modifier 340 updates the representations from a previous incremental training batch based on the representations (e.g., model weights) associated with the loss function. The exemplars generator 345 selects a set of samples from the training data 310 for each device class to be exemplars utilized for subsequent incremental training batches. The exemplars mean modifier 350 calculates the overall mean of a device class by calculating the mean of output vectors for each sample of the device class.

The device identifier 150 may perform classification at the output layer by calculating the nearest means of exemplars associated with fingerprints received for device identification.

While an example manner of implementing the example device identification service 115 of FIG. 1 is illustrated in FIGS. 1, 2, and/or 3, one or more of the elements, processes and/or devices illustrated in FIGS. 1, 2, and/or 3 may be combined, divided, re-arranged, omitted, eliminated and/or implemented in any other way. Further, the example vocabulary generator 125, the example model generator 130, the example models 101, the example representation modifier 140, the exemplar memory 145, and the example device identifier 150 and/or, more generally, the example device identification service 115 of FIGS. 1, 2, and/or 3 may be implemented by hardware, software, firmware and/or any combination of hardware, software and/or firmware. Thus, for example, any of the example vocabulary generator 125, the example model generator 130, the example models 101, the example representation modifier 140, the exemplar memory 145, and the example device identifier 150 and/or, more generally, the example device identification service 115 of FIGS. 1, 2, and/or 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example vocabulary generator 125, the example model generator 130, the example models 101, the example representation modifier 140, the exemplar memory 145, and the example device identifier 150 and/or, more generally, the example device identification service 115 of FIGS. 1, 2, and/or 3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example device identification service 115 of FIGS. 1, 2, and/or 3 may include one or more elements, processes and/or devices in addition to, or instead of, those illustrated in FIGS. 1, 2, and/or 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

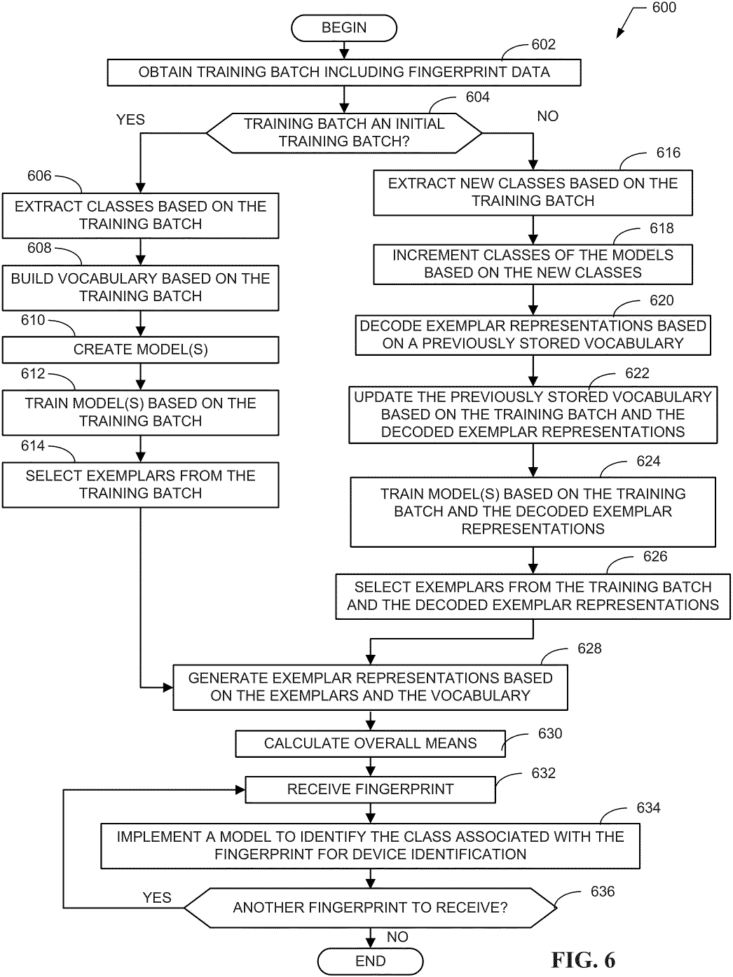

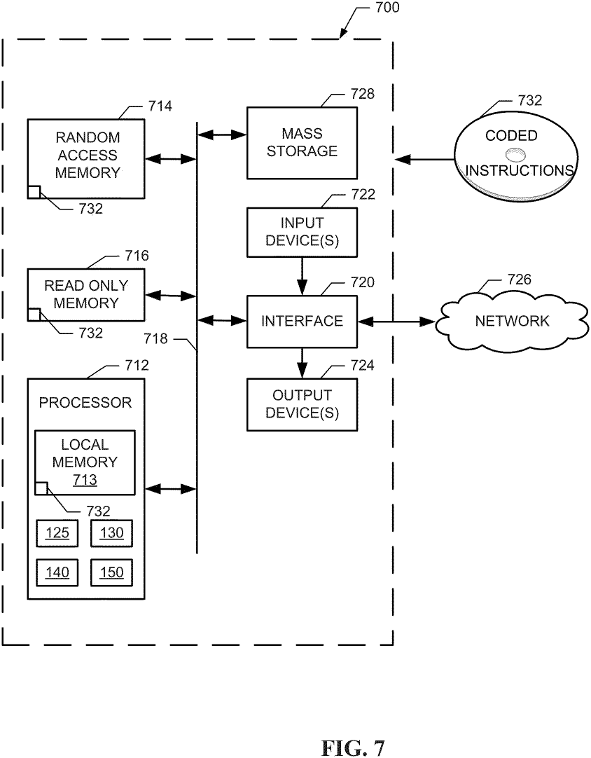

A flowchart representative of example hardware logic, machine readable instructions, hardware implemented state machines, and/or any combination thereof for implementing the example device identification service 115 of FIGS. 1, 2, and/or 3 is shown in FIG. 6. The machine readable instructions may be one or more executable programs or portion(s) of an executable program for execution by a computer processor and/or processor circuitry, such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIG. 6, many other methods of implementing the example device identification service 115 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or’’ when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

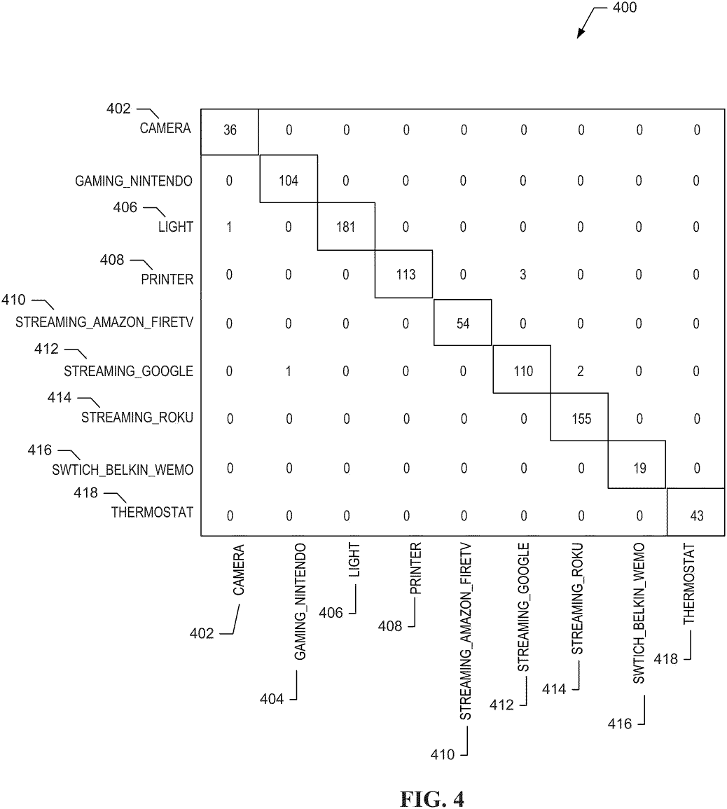

FIG. 4 is an illustration of an example decision matrix 400 for use in training a model utilizing a complete data set. For example, the model is implementing a model from the models 101 of FIG. 1. The model may be trained to predict device type based on the complete data set (e.g., a non-incremental classifier). In one example, the complete data set includes fingerprint data collected from the following device classes: an example camera 402 (Camera), an example gaming Nintendo® 404 (Gaming_Nintendo), an example light 406 (Light), an example printer 408 (Printer), an example Amazon Fire TV stick 410 (Streaming _Amazon_FireTV), an example Google Chromecast 412 (Streaming_Google), an example Roku® Streaming StickⓇ 414 (Streaming_Roku), an example Belkin™ Wemo® Switch 416 (Switch_Belkin_Wemo), and an example thermostat 418 (Thermostat). All fingerprint data is retained. Therefore, when new fingerprint data is obtained, the model is re-trained based on a complete data set, which includes all of the old fingerprint data and the new fingerprint data. The example decision matrix 400 illustrates the performance of the model trained on the complete data set. The rows correspond to the actual class device corresponding to fingerprints to be identified by the device identification service 115. The columns correspond to the class device predicted by the device identification service 115. The decision matrix 400 shows the accuracy of the model trained with the complete set of data. For example, the device identification service 115 correctly classified 181 fingerprints from the light 406 as the light 406. However, the device identification service 115 incorrectly classified one fingerprint from the light 406 as a camera 402. In one example, the accuracy of the model is 99.24% (e.g., percentage of correctly identifying devices).

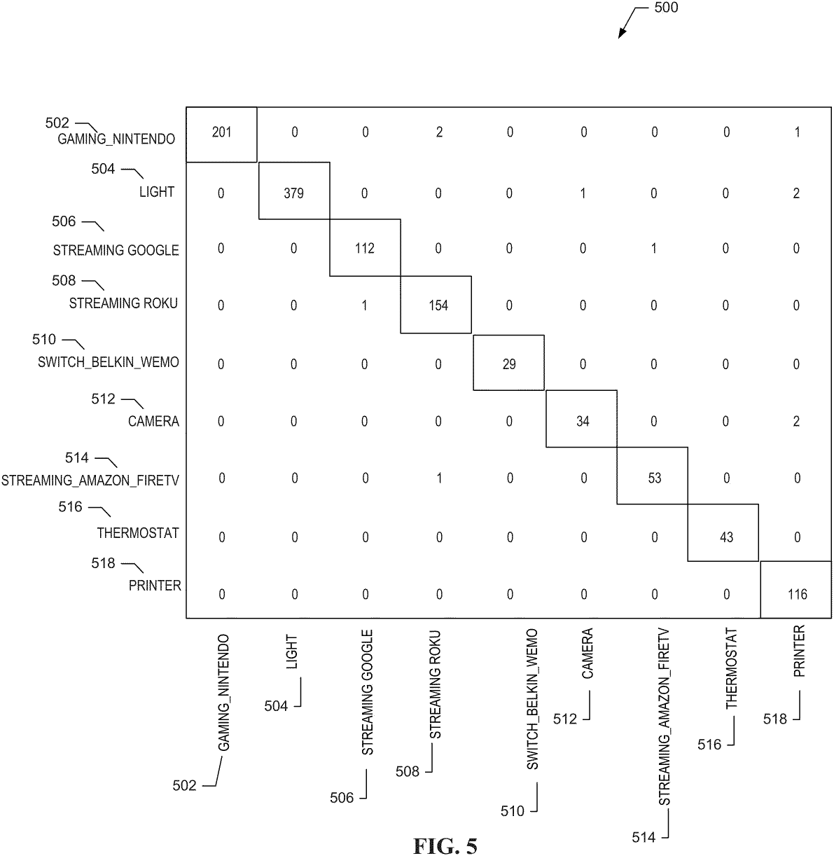

FIG. 5 is an illustration of an example decision matrix 500 for use in incrementally training a model. For example, the model is implementing a model from the models 101 of FIG. 1. In this example, the model is incrementally trained for four training batches based on new fingerprint data and stored exemplar representations described in connection FIGS. 1, 2, and/or 3. The model is not trained on a complete data set, yet the model still identifies the device classes corresponding to fingerprints with high accuracy. In one example, the four training batches of data include fingerprint data collected from the following device types: an example gaming Nintendo® 502 (Gaming_Nintendo), an example light 504 (Light), an example Google Chromecast 506 (Streaming _Google), an example Roku® Streaming Stick® 508 (Streaming_Roku), an example Belkin™ Wemo® Switch 510 (Switch_Belkin_Wemo), an example camera 512 (Camera), an example Amazon Fire TV stick 514 (Streaming_Amazon_FireTV), and an example thermostat 516 (Thermostat), and an example printer 518 (Printer). The example decision matrix 500 illustrates the performance of the model trained after four training batches of incremental training. The rows correspond to the actual device class corresponding to fingerprints to be identified by the device identification service 115. The columns correspond to the device class predicted by the device identification service 115. The decision matrix 500 shows the accuracy of the model trained with the complete set of data. For example, the device identification service 115 correctly classified 379 fingerprints from the light 504 as the light 504. However, the device identification service 115 incorrectly classified one fingerprint from the light 504 as a camera 512 and two fingerprints from the light 504 as a printer 508.

In one example, the top percentage of samples stored after each training batch (as described in connection to FIG. 1) varies, which causes variation in the accuracy of the model (e.g., percentage of correctly identifying devices). For example, table 2 below shows the percentages of top samples stored for each device class and the corresponding accuracies after incrementally training four training batches.

Table 2

| Samples Stored (%) | Accuracy of the Model (%) |
|---|---|
| 10 | 97.05 |
| 15 | 98.69 |
| 20 | 98.45 |
| 25 | 98.80 |

In some examples, a variation of 0.5% change in accuracy is acceptable to be utilized in incremental learning approaches. Therefore, the gains above 15% of the top samples stored for each device class are within the acceptable 0.5% change in accuracy. As a result, 15% may be the top percentage of samples per class retained for each incremental training batch.

In some examples, the accuracy of the model (e.g., percentage of correctly identifying devices) varies after each incremental training batch. For example, table 3 below shows the accuracy of the model per incremental training batch, while retaining 15% of the top samples per class, along with the new device classes and total device classes.

Table 3

| Training Batch | Total Device Classes | New Device Classes | Accuracy of the Model (%) |
|---|---|---|---|
| T1 | 5 | 5 | 99.55% |
| T2 | 6 | 1 | 98.73% |
| T3 | 7 | 2 | 97.02% |
| T4 | 9 | 1 | 98.69% |

For example, “T1” in table 3 corresponds to the initial training batch associated with five device classes extracted from fingerprint data. The model may be trained based on the initial training batch. The accuracy of the model after the training is complete may be 99.55%. For example, “T4” corresponds to the fourth training batch associated with one device class extracted from fingerprint data and nine total device classes. The nine total device classes may include eight device classes previously trained by the model from stored exemplars and the one new device class. The accuracy of the model after the training is complete may be 98.69%. The performance degradation is minimal (e.g., the gap between the accuracy of the final incremental step and the accuracy of a non-incremental classifier).

FIG. 6 is a flowchart representative of an example process 600 that may be performed using machine readable instructions which may be executed to implement the example device identification service 115 of FIGS. 1, 2, and/or 3 to train the models 101. At block 605, the process begins when the vocabulary generator 125 obtains a training batch including fingerprint data. The vocabulary generator 125 may receive the training batch from the secure platform 120. In some examples, the secure platform 120 sends the training batch after collecting fingerprints included in the training batch for a period of time. The fingerprint data may be text data including samples associated with devices from the devices 102, 104, 106, 108 of FIG. 1.

At block 604, the vocabulary generator 125 determines whether the training batch is an initial training batch. If the vocabulary generator 125 determines the training batch is an initial training batch (e.g., block 604 returns a result of “YES”), the vocabulary generator 125 continues to block 606. The training batch being an initial training batch indicates the models 101 have not been previously trained. If the vocabulary generator 125 determines the training batch is not an initial training batch (e.g., block 604 returns a result of “NO”), the vocabulary generator 125 continues to block 616. The training batch not being an initial training batch indicates the models 101 have not been previously trained.

At block 606, the vocabulary generator 125 extracts device classes based on the training batch. The device classes may include one or more class types such as, for example, device type, manufacturer information, device model information, etc. In one example, the device classes extracted correspond to a device type and include a gaming Nintendo®, a light, Google Chromecast, Roku® Streaming Stick®, and Belkin™ Wemo® Switch. At block 608, the vocabulary generator 125 builds a vocabulary based on the training batch. In some examples, the vocabulary is a hash map including keys that map to values. The vocabulary generator 125 may determine the keys by tokenizing the text-based fingerprint data included in the training batch. The tokenized text-based fingerprint data may be words of primary domain names. The vocabulary generator 125 may select the words occurring most frequently to form the keys. The values may indicate the frequency of occurrence of the set of the words.

At block 610, the model generator 130 creates one or more models. The one or more models may correspond to the models 101 in FIG. 1. The model generator 130 creates the models 101 based on the class types extracted by the vocabulary generator 125. For instance, in some examples, the models 101 include a first model that can be used to predict the device type. At block 612, the model generator 130 trains the one or more models based on the training batch. For example, the model generator 130 directs a model from the models 101 to output the correct device class for each sample included in the training batch. At block 614, the representation modifier 140 selects exemplars from the training batch. A set of samples from each device class is selected to be exemplars. In some examples, a set of the samples for a device class are the samples including the means closest to the overall mean for the device class.

At block 616, the vocabulary generator 125 extracts new device classes based on the training batch. For example, the training batch includes a device class not present in previous incremental training batches utilized to train the models. Alternatively, no new device classes are included in the training batch. At block 618, the model generator 130 increments device classes of the models 101 based on the new device classes. For example, the device classes of the models 101 are incremented to include the new device classes. Alternatively, no new device classes are included in the training batch, therefore, the device classes are not incremented. At block 620, the representation modifier 140 decodes the exemplar representations based on a previously stored vocabulary. In some examples, the vocabulary is stored in the exemplar memory 145 from a previous training batch. At block 622, the model generator 130 updates the previously stored vocabulary based on the training batch and the decoded exemplar representations. For example, new words (e.g., domains) are included in the training batch that are not included in the stored vocabulary. As a result, the vocabulary is updated to include the new words. In another example, old words (e.g., domains) included in the stored vocabulary are not in the training batch and the decoded exemplar representations. As a result, the vocabulary is updated to omit the old words not in the training batch and the decoded exemplar representations.

At block 624, the model generator 130 trains one or more models based on the training batch and the decoded exemplar representations. In one example, the model generator 130 trains a model from the one or more models (e.g., the models 101) by minimizing a loss function (objective function), which includes directing the model to output the correct device class for each sample included in the fingerprint data (e.g., loss for classification) and directing the model to reproduce the output of the correct old device class for each decoded exemplar representation (e.g., distillation loss). At block 626, the representation modifier 140 selects exemplars from the training batch including both the fingerprint data and the decoded exemplar representations. A set of samples from each device class is selected to be exemplars. In some examples, a set of the samples for a device class are the samples including the means closest to the overall mean for the device class.

At block 628, the representation modifier 140 generates exemplar representations based on the exemplars and the vocabulary. For example, the representation modifier 140 encodes the exemplars based on the vocabulary to generate the exemplar representations. At block 630, the model generator 130 calculates overall means. The overall means are calculated for each device class. For example, an overall mean of a device class is the mean of output vectors for each sample of the device class. At block 632, the device identifier 150 receives a fingerprint. In some examples, the fingerprint corresponds to a device from the devices 102, 104, 106, 108 that needs to be identified. At block 634, the device identifier 150 implements a model to identify the device class associated with the fingerprint for device identification. For example, the device identifier 150 classifies the fingerprint to the device class associated with the nearest mean of exemplars. In response to device identification, the device identifier 150 may enforce security policies associated with the device class.

At block 636, the device identifier 150 determines whether another fingerprint is to be received. If the device identifier 150 determines another fingerprint is to be received (e.g., block 636 returns a result of “YES”), the device identifier 150 returns to block 632. If the device identifier 150 determines another fingerprint is not to be received (e.g., block 636 returns a result of “NO”), the example instructions 600 of FIG. 6 terminate.

FIG. 7 is a block diagram of an example processor platform 700 structured to execute the instructions of FIG. 6 to implement the example device identification service 115 of FIGS. 1, 2, and/or 3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example vocabulary generator 125, the example model generator 130, the example representation modifier 140, and the example device identifier 150.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIG. 6 may be stored in the mass storage device 728, in the volatile memory 714, in the non-volatile memory 716, and/or on a removable non-transitory computer readable storage medium such as a CD or DVD.

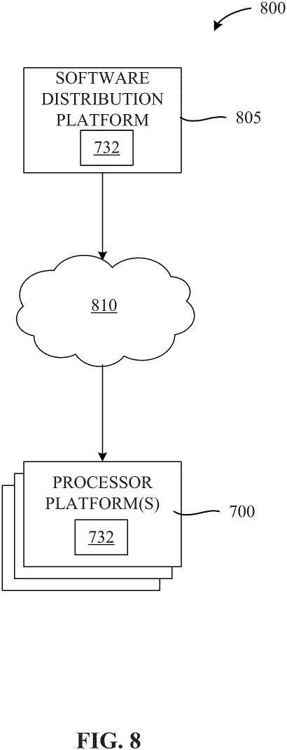

A block diagram illustrating an example software distribution platform 805 to distribute software such as the example computer readable instructions 732 of FIG. 7 to third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 7. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the computer readable instructions 732, which may correspond to the example computer readable instructions 600 of FIG. 6 as described above. The one or more servers of the example software distribution platform 805 are in communication with a network 810, which may correspond to any one or more of the Internet and/or any of the example networks 710 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 732 from the software distribution platform 805. For example, the software, which may correspond to the example computer readable instructions 600 of FIG. 6, may be downloaded to the example processor platform 800, which is to execute the computer readable instructions 732 to implement the example device identification service 115. In some example, one or more servers of the software distribution platform 805 periodically offer, transmit, and/or force updates to the software (e.g., the example computer readable instructions 732 of FIG. 7) to ensure improvements, patches, updates, etc. are distributed and applied to the software at the end user devices.

From the foregoing, it will be appreciated that example methods, apparatus and articles of manufacture have been disclosed that overcome the challenges that arise from the cost constraints of data retention and the data privacy and protection laws by implementing an incremental learning approach for a model. The disclosed methods, apparatus and articles of manufacture improve the efficiency of using a computing device by storing exemplar representations in an encoded form to provide privacy compliance, reduce monetary costs associated with data storage and processing, and prevent catastrophic forgetting. Further, the incremental learning approach updates input features and device classes without the need for retraining the models from scratch. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Example methods and apparatus to incrementally train a model are disclosed herein. Further examples and combinations thereof include the following:

Example 1 includes an apparatus comprising at least one memory, instructions, and processor circuitry to execute the instructions to at least obtain first data from a first network device, the first data associated with a first device class not previously associated with the processor circuitry, build a vocabulary including keys that map to values for an incremental training batch, the incremental training batch based on the first data and exemplars from the at least one memory, the exemplars associated with a set of device classes previously associated with the processor circuitry, wherein the exemplars include first means closest to first overall means for ones of the set of the device classes that were stored to the at least one memory during a previous incremental training batch, update the set of the device classes to include the first device class, train a model based on the keys as input features and the updated set of the device classes, select a set of samples from the first data and the exemplars, wherein the set of the samples include second means closest to second overall means for ones of the updated set of the device classes, and update the exemplars in the at least one memory to correspond to the set of the samples for a subsequent incremental training batch.

Example 2 includes the apparatus of example 1, wherein the first data is text data, the text data corresponding to at least one of Universal Plug and Play (UPnP) data, multicast domain name system (mDNS) data, or domain name system (DNS) data.

Example 3 includes the apparatus of example 1, wherein the processor circuitry is to build the vocabulary by splitting the first data into words, selecting a subset of the words to form the keys based on frequency of occurrence of the words in the first data, and generating a hash map of the keys and the values, the keys being the subset of the words, the values indicating the frequency of occurrence of the subset of the words.

Example 4 includes the apparatus of example 1, wherein the processor circuitry is to update the exemplars in the at least one memory to correspond to the set of the samples to reduce monetary costs associated with data storage and data processing.

Example 5 includes the apparatus of example 1, wherein the second means include third means and fourth means, wherein the second overall means include a third overall mean and a fourth overall mean, wherein the processor circuitry is to further calculate the third overall mean and the fourth overall mean, the third overall mean based on first output vectors corresponding to first samples from the first data, the fourth overall mean based on second output vectors corresponding to second samples from the exemplars, the first samples associated with the first device class, the second samples associated with a second device class from the set of the device classes, and calculate the third means and the fourth means, the third means corresponding to the first output vectors, the fourth means corresponding to the second output vectors.

Example 6 includes the apparatus of example 5, wherein the set of the samples includes a first subset of the samples and a second subset of the samples, the first subset of the samples including a first fraction of the first samples with third means closest to the third overall mean, the second subset of the samples including a second fraction of the second samples with fourth means closest to the fourth overall mean.

Example 7 includes the apparatus of example 1, wherein the processor circuitry is to update the exemplars in the at least one memory to correspond to the set of samples by matching words included in the set of the samples to a set of the keys, determining a set of the values corresponding to the words, and encoding the set of the samples to a sequence of numbers based on the set of the values.

Example 8 includes the apparatus of example 7, wherein the processor circuitry is to encode the set of the samples to prevent storing personally identifiable information.

Example 9 includes the apparatus of example 1, wherein the device classes correspond to at least one of device types, device manufacturers, and device model information.

Example 10 includes the apparatus of example 1, wherein the processor circuitry is to further implement the model to identify a second device class associated with second data corresponding to a second network device, the second device class from the updated set of device classes.

Example 11 includes the apparatus of example 10, wherein the processor circuitry is to further enforce security policies for the second network device based on the second device class.

Example 12 includes an apparatus comprising a vocabulary generator to obtain first data from a first network device, the first data associated with a first device class not previously associated with the vocabulary generator, build a vocabulary including keys that map to values for an incremental training batch, the incremental training batch based on the first data and exemplars from a memory, the exemplars associated with a set of device classes previously associated with the vocabulary generator, wherein the exemplars including first means closest to first overall means for ones of the set of the device classes were stored to the memory during a previous incremental training batch, and update the set of the device classes to include the first device class, a representation modifier to select a set of samples from the first data and the exemplars, wherein the set of the samples include second means closest to second overall means for ones of the updated set of the device classes, and a model generator to train a model based on the keys as input features and the updated set of the device classes, and update the exemplars in the memory to correspond to the set of the samples for a subsequent incremental training batch.

Example 13 includes the apparatus of example 12, wherein the first data is text data, the text data corresponding to at least one of Universal Plug and Play (UPnP) data, multicast domain name system (mDNS) data, or domain name system (DNS) data.

Example 14 includes the apparatus of example 12, wherein the vocabulary generator is to build the vocabulary by splitting the first data into words, selecting a subset of the words to form the keys based on frequency of occurrence of the words in the first data, and generating a hash map of the keys and the values, the keys being the subset of the words, the values indicating the frequency of occurrence of the subset of the words.

Example 15 includes the apparatus of example 12, wherein the model generator is to update the exemplars in the memory to correspond to the set of the samples to reduce monetary costs associated with data storage and data processing.

Example 16 includes the apparatus of example 12, wherein the second means include third means and fourth means, wherein the second overall means include a third overall mean and a fourth overall mean, wherein the model generator is to further calculate the third overall mean and the fourth overall mean, the third overall mean based on first output vectors corresponding to first samples from the first data, the fourth overall mean based on second output vectors corresponding to second samples from the exemplars, the first samples associated with the first device class, the second samples associated with a second device class from the set of the device classes, and calculate the third means and the fourth means, the third means corresponding to the first output vectors, the fourth means corresponding to the second output vectors.

Example 17 includes the apparatus of example 16, wherein the set of the samples includes a first subset of the samples and a second subset of the samples, the first subset of the samples including a first fraction of the first samples with third means closest to the third overall mean, the second subset of the samples including a second fraction of the second samples with fourth means closest to the fourth overall mean.

Example 18 includes the apparatus of example 12, wherein the representation modifier is to update the exemplars in the memory to correspond to the set of the samples by matching words included in the set of the samples to a set of the keys, determining a set of the values corresponding to the words, and encoding the set of the samples to a sequence of numbers based on the set of the values.

Example 19 includes the apparatus of example 18, wherein the representation modifier is to encode the set of the samples to prevent storing personally identifiable information.

Example 20 includes the apparatus of example 12, wherein the device classes correspond to at least one of device types, device manufacturers, and device model information.

Example 21 includes the apparatus of example 12, further including a device identifier to implement the model to identify a second device class associated with second data corresponding to a second network device, the second device class from the updated set of the device classes.

Example 22 includes the apparatus of example 21, wherein the device identifier is to further enforce security policies for the second network device based on the second device class.

Example 23 includes a non-transitory computer readable medium comprising instructions that when executed cause at least one processor to obtain first data from a first network device, the first data associated with a first device class not previously associated with the at least one processor, build a vocabulary including keys that map to values for an incremental training batch, the incremental training batch based on the first data and exemplars from a memory, the exemplars associated with a set of device classes previously associated with the at least one processor, wherein the exemplars including first means closest to first overall means for ones of the set of the device classes were stored to the memory during a previous incremental training batch, update the set of the device classes to include the first device class, train a model based on the keys as input features and the updated set of the device classes, and select a set of samples from the first data and the exemplars, wherein the set of the samples include second means closest to second overall means for ones of the updated set of the device classes, and update the exemplars in the memory to correspond to the set of the samples for a subsequent incremental training batch.

Example 24 includes the non-transitory computer readable medium of example 23, wherein the first data is text data, the text data corresponding to at least one of Universal Plug and Play (UPnP) data, multicast domain name system (mDNS) data, or domain name system (DNS) data.

Example 25 includes the non-transitory computer readable medium of example 23, wherein the at least one processor is to build the vocabulary by splitting the first data into words, selecting a subset of the words to form the keys based on frequency of occurrence of the words in the first data, and generating a hash map of the keys and the values, the keys being the subset of the words, the values indicating the frequency of occurrence of the subset of the words.

Example 26 includes the non-transitory computer readable medium of example 23, wherein the at least one processor is to update the exemplars in the memory to correspond to the set of the samples to reduce monetary costs associated with data storage and data processing.

Example 27 includes the non-transitory computer readable medium of example 23, wherein the second means include third means and fourth means, wherein the second overall means include a third overall mean and a fourth overall mean, wherein the at least one processor is to further calculate the third overall mean and the fourth overall mean, the third overall mean based on first output vectors corresponding to first samples from the first data, the fourth overall mean based on second output vectors corresponding to second samples from the exemplars, the first samples associated with the first device class, the second samples associated with a second device class from the set of the device classes, and calculate the third means and the fourth means, the third means corresponding to the first output vectors, the fourth means corresponding to the second output vectors.

Example 28 includes the non-transitory computer readable medium of example 27, wherein the set of the samples includes a first subset of the samples and a second subset of the samples, the first subset of the samples including a first fraction of the first samples with third means closest to the third overall mean, the second subset of the samples including a second fraction of the second samples with fourth means closest to the fourth overall mean.

Example 29 includes the non-transitory computer readable medium of example 23, wherein the at least one processor is to update the exemplars in the memory to correspond to the set of the samples by matching words included in the set of the samples to a set of the keys, determining a set of the values corresponding to the words, and encoding the set of the samples to a sequence of numbers based on the set of the values.

Example 30 includes the non-transitory computer readable medium of example 29, wherein the at least one processor is to encode the set of the samples to prevent storing personally identifiable information.

Example 31 includes the non-transitory computer readable medium of example 23, wherein the device classes correspond to at least one of device types, device manufacturers, and device model information.

Example 32 includes the non-transitory computer readable medium of example 23, wherein the at least one processor is to further implement the model to identify a second device class associated with second data corresponding to a second network device, the second device class from the updated set of the device classes.

Example 33 includes the non-transitory computer readable medium of example 32, wherein the at least one processor is to further enforce security policies for the second network device based on the second device class.

The following claims are hereby incorporated into this Detailed Description by this reference, with each claim standing on its own as a separate embodiment of the present disclosure.

1. An apparatus comprising:
at least one memory;
instructions; and
processor circuitry to execute the instructions to at least:
obtain first data from a first network device, the first data associated with a
first device class not previously associated with the processor circuitry;
build a vocabulary including keys that map to values for an incremental training batch, the incremental training batch based on the first data and exemplars from the at least one memory, the exemplars associated with a set of device classes previously associated with the processor circuitry, wherein the exemplars include first means closest to first overall means for ones of the set of the device classes that were stored to the at least one memory during a previous incremental training batch;
update the set of the device classes to include the first device class;
train a model based on the keys as input features and the updated set of the device classes;
select a set of samples from the first data and the exemplars, wherein the set of the samples include second means closest to second overall means for ones of the updated set of the device classes; and
update the exemplars in the at least one memory to correspond to the set of the samples for a subsequent incremental training batch.

2. The apparatus of claim 1, wherein the first data is text data, the text data corresponding to at least one of Universal Plug and Play (UPnP) data, multicast domain name system (mDNS) data, or domain name system (DNS) data.

3. The apparatus of claim 1, wherein the processor circuitry is to build the vocabulary by:
splitting the first data into words;
selecting a subset of the words to form the keys based on frequency of occurrence of the words in the first data; and
generating a hash map of the keys and the values, the keys being the subset of the words, the values indicating the frequency of occurrence of the subset of the words.

4. The apparatus of claim 1, wherein the processor circuitry is to update the exemplars in the at least one memory to correspond to the set of the samples to reduce monetary costs associated with data storage and data processing.

5. The apparatus of claim 1, wherein the second means include third means and fourth means, wherein the second overall means include a third overall mean and a fourth overall mean, wherein the processor circuitry is to further:
calculate the third overall mean and the fourth overall mean, the third overall mean based on first output vectors corresponding to first samples from the first data, the fourth overall mean based on second output vectors corresponding to second samples from the exemplars, the first samples associated with the first device class, the second samples associated with a second device class from the set of the device classes; and
calculate the third means and the fourth means, the third means corresponding to the first output vectors, the fourth means corresponding to the second output vectors.

6. The apparatus of claim 5, wherein the set of the samples includes a first subset of the samples and a second subset of the samples, the first subset of the samples including a first fraction of the first samples with third means closest to the third overall mean, the second subset of the samples including a second fraction of the second samples with fourth means closest to the fourth overall mean.

7. The apparatus of claim 1, wherein the processor circuitry is to update the exemplars in the at least one memory to correspond to the set of samples by:
matching words included in the set of the samples to a set of the keys;
determining a set of the values corresponding to the words; and
encoding the set of the samples to a sequence of numbers based on the set of the values.

8. The apparatus of claim 7, wherein the processor circuitry is to encode the set of the samples to prevent storing personally identifiable information.

9. The apparatus of claim 1, wherein the device classes correspond to at least one of device types, device manufacturers, and device model information.

10. The apparatus of claim 1, wherein the processor circuitry is to further implement the model to identify a second device class associated with second data corresponding to a second network device, the second device class from the updated set of device classes.

11. The apparatus of claim 10, wherein the processor circuitry is to further enforce security policies for the second network device based on the second device class.

12. An apparatus comprising:
a vocabulary generator to:
obtain first data from a first network device, the first data associated with a
first device class not previously associated with the vocabulary generator;
build a vocabulary including keys that map to values for an incremental training batch, the incremental training batch based on the first data and exemplars from a memory, the exemplars associated with a set of device classes previously associated with the vocabulary generator, wherein the exemplars including first means closest to first overall means for ones of the set of the device classes were stored to the memory during a previous incremental training batch; and
update the set of the device classes to include the first device class;
a representation modifier to select a set of samples from the first data and the exemplars, wherein the set of the samples include second means closest to second overall means for ones of the updated set of the device classes; and
a model generator to:
train a model based on the keys as input features and the updated set of the device classes; and
update the exemplars in the memory to correspond to the set of the samples for a subsequent incremental training batch.

13. The apparatus of claim 12, wherein the first data is text data, the text data corresponding to at least one of Universal Plug and Play (UPnP) data, multicast domain name system (mDNS) data, or domain name system (DNS) data.

14. The apparatus of claim 12, wherein the vocabulary generator is to build the vocabulary by:
splitting the first data into words;
selecting a subset of the words to form the keys based on frequency of occurrence of the words in the first data; and
generating a hash map of the keys and the values, the keys being the subset of the words, the values indicating the frequency of occurrence of the subset of the words.

15. The apparatus of claim 12, wherein the model generator is to update the exemplars in the memory to correspond to the set of the samples to reduce monetary costs associated with data storage and data processing.

16. The apparatus of claim 12, wherein the second means include third means and fourth means, wherein the second overall means include a third overall mean and a fourth overall mean, wherein the model generator is to further:
calculate the third overall mean and the fourth overall mean, the third overall mean based on first output vectors corresponding to first samples from the first data, the fourth overall mean based on second output vectors corresponding to second samples from the exemplars, the first samples associated with the first device class, the second samples associated with a second device class from the set of the device classes; and
calculate the third means and the fourth means, the third means corresponding to the first output vectors, the fourth means corresponding to the second output vectors.

17. The apparatus of claim 16, wherein the set of the samples includes a first subset of the samples and a second subset of the samples, the first subset of the samples including a first fraction of the first samples with third means closest to the third overall mean, the second subset of the samples including a second fraction of the second samples with fourth means closest to the fourth overall mean.

18. The apparatus of claim 12, wherein the representation modifier is to update the exemplars in the memory to correspond to the set of the samples by:
matching words included in the set of the samples to a set of the keys;
determining a set of the values corresponding to the words; and
encoding the set of the samples to a sequence of numbers based on the set of the values.

19. The apparatus of claim 18, wherein the representation modifier is to encode the set of the samples to prevent storing personally identifiable information.

20. The apparatus of claim 12, wherein the device classes correspond to at least one of device types, device manufacturers, and device model information.

21. The apparatus of claim 12, further including a device identifier to implement the model to identify a second device class associated with second data corresponding to a second network device, the second device class from the updated set of the device classes.

22. The apparatus of claim 21, wherein the device identifier is to further enforce security policies for the second network device based on the second device class.

23. A non-transitory computer readable medium comprising instructions that when executed cause at least one processor to:
obtain first data from a first network device, the first data associated with a first device class not previously associated with the at least one processor;
build a vocabulary including keys that map to values for an incremental training batch, the incremental training batch based on the first data and exemplars from a memory, the exemplars associated with a set of device classes previously associated with the at least one processor, wherein the exemplars including first means closest to first overall means for ones of the set of the device classes were stored to the memory during a previous incremental training batch;
update the set of the device classes to include the first device class;
train a model based on the keys as input features and the updated set of the device classes;
select a set of samples from the first data and the exemplars, wherein the set of the samples include second means closest to second overall means for ones of the updated set of the device classes; and
update the exemplars in the memory to correspond to the set of the samples for a subsequent incremental training batch.

24. The non-transitory computer readable medium of claim 23, wherein the first data is text data, the text data corresponding to at least one of Universal Plug and Play (UPnP) data, multicast domain name system (mDNS) data, or domain name system (DNS) data.

25. The non-transitory computer readable medium of claim 23, wherein the at least one processor is to build the vocabulary by:
splitting the first data into words;
selecting a subset of the words to form the keys based on frequency of occurrence of the words in the first data; and
generating a hash map of the keys and the values, the keys being the subset of the words, the values indicating the frequency of occurrence of the subset of the words.

26-33. (canceled)
